(19) United States
(12) Patent Application Publication
(10) Pub. No.: US 2012/0083989 A1
(43) Pub. Date: Apr. 5, 2012

(54) COMBUSTION DETECTING METHOD OF ENGINE

(75) Inventors: Kyoungchan Han, Hwaseong-si (KR); Sunghwan Cho, Yongin-city (KR); Myoungho Sunwoo, Seoul (KR); Seungsuk Oh, Siheung-si (KR); Jongsuk Lim, Seoul (KR); Jaesung Chung, Seoul (KR); Kangyoon Lee, Seoul (KR)

(73) Assignees: IUCF-HYU (Industry-University Cooperation Foundation Hanyang University), Seoul (KR); Hyundai Motor Company, Seoul (KR)

(21) Appl. No.: 13/236,346

(22) Filed: Sep. 19, 2011

(30) Foreign Application Priority Data
Sep. 30, 2010 (KR) 10-2010-0094888

(51) Int. Cl. G01M 15/04

(52) U.S. Cl. 701/99

(57) ABSTRACT

A combustion phase detection method is able to reduce exhaust gas and to improve combustion stability, to compensate injection and ignition delay time between combustion chambers and between cycles, and to detect a combustion phase in real time such that a heat generation rate and a heat release can be effectively calculated at an early state of the combustion by using a combustion pressure and a motoring pressure difference of an engine not affected by an offset value of the cylinder pressure. The combustion phase detection method of an engine may include detecting a combustion phase according to fuel injection timing by using a specific point of DHdP that is calculated by the following heat release equation:

DHdP:∫1/γ−1VdP_{diff}/dθdθ.

Here, Pdiff is a difference (Pdiff=P−Pmotoring) between a cylinder measure combustion pressure (P) and a motoring pressure (Pmotoring).

### CROSS-REFERENCE TO RELATED APPLICATION

This application claims priority to and the benefit of Korean Patent Application No. 10-2010-0094888 filed Sep. 30, 2010, the entire contents of which application is incorporated herein for all purposes by this reference.

### BACKGROUND OF INVENTION

1. Field of Invention

The present invention relates to a combustion phase detection method of an engine that uses a combustion pressure thereof and a change rate of a motoring pressure difference.

2. Description of Related Art

In an internal combustion engine, an abnormal combustion process, for example, knocking, can be generated by spontaneous combustion of an unburned mixture that a fire does not yet reach. Long continued knocking can damage components of the combustion chamber by an increment of heat load and pressure shock.

An important parameter that affects a knocking tendency of the internal combustion engine is ignition timing. If the fuel/air mixture in the combustion chamber is ignited too early, the knocking can be generated. Accordingly, after a knocking process is detected in the internal combustion engine, there is a method that retards ignition timing so as to prevent the knocking at a next combustion stroke.

Excessively retarded ignition is related to efficiency loss, and accordingly a knocking control apparatus is used to detect knocking during combustion in the internal combustion engine. This part of knocking control is knocking detection. Meanwhile, the ignition angle is adjusted during knocking control. Knocking control like this is published in an international patent application PCT/DE 91/00170. Other adjustment parameters such as fuel/air mixture, charging, compression ratio, an engine operating point, and so on can be varied so as to reduce knocking sensitivity of the internal combustion engine.

Also, knocking control is separately performed for each cylinder, and in addition to knocking detection, separately adjusting an ignition angle for each cylinder has been published. Since a structure difference of a cylinder, inequitable distribution of knocking sensors, and a related knocking signal of a cylinder generate differences of cylinders in knocking control, a separate knocking control for each cylinder is to be used to optimize efficiency thereof and simultaneously knocking sensitivity is deteriorated thereby.

If the phase detection portion, in which signals based on synchronization of ignition and knocking control are transferred, breaks down, a new demand condition is given to the knocking control that is separately performed for each cylinder. The knocking control is performed with maximum security and maximum accuracy so as to achieve maximum efficiency, due to possible damage of the internal combustion engine and stability of the combustion.

On this account, the necessity for the combustion phase control shows a steady growth to achieve stability of the combustion and noxious exhaust gas reduction.

Generally, the combustion phase control method includes calculating total heat release (referring to a total heat release of FIG. 1) by using the following equation and a pressure inside the combustion chamber, and detecting a combustion phase by using a specific point of the total heat release (for example, 50% of the total heat release, MFB 50: 0.5 value of axis y coordinate of FIG. 1).

$$\frac{d Q}{d θ} = \frac{1}{γ - 1} V \frac{d P}{d θ} + \frac{γ}{γ - 1} P \frac{d V}{d θ}$$

However, since the above heat generation analysis method is based on a thermal dynamics rule and it is very complicated mathematically and has a large size of calculation load, it is effective in a case that it is analyzed at a theoretical side with sufficient time, but there is a drawback that it is difficult to apply it to the combustion of the engine that is performed in real time.

Also, in the combustion phase detection method that uses a 50% point of the heat generation (MFB 50), as shown in FIG. 2, there was a problem that a larger error is generated in detecting the combustion phase, in a case that an offset is formed in a sensor measure value by heat impact when the cylinder combustion pressure is measured, as shown in a square pattern mark coordinator of FIG. 3, compared to a normal circle mark coordinator.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a combustion phase detection method of an engine having advantages of being able to reduce exhaust gas and to improve combustion stability, to compensate injection and ignition delay time between combustion chambers and between cycles, and to detect a combustion phase in real time such that a heat generation rate and heat release can be effectively calculated in an early state of combustion with a simple calculation method to control combustion of an engine, by using a combustion pressure and a motoring pressure difference of an engine not affected by an offset value of the cylinder pressure.

In various aspects, the combustion phase detection method of an engine according may include detecting a combustion phase according to fuel injection timing by using a specific point of DHdP that is calculated by the following heat release equation:

$$DHdP \text{:} \int \frac{1}{γ - 1} V \frac{d {P}_{diff}}{d θ} d θ$$

Here, Pdiff is a difference (Pdiff=P−Pmotoring) between a cylinder measure combustion pressure (P) and a motoring pressure (Pmotoring).

The DHdP may be normalized by:

$$Normalized DHdP \text{:} \frac{\int V \frac{d {P}_{diff}}{d θ} d θ}{max ( \int V \frac{d {P}_{diff}}{d θ} d θ )}$$

The specific point of the DHdP ranging from 0 to 50% may be used to detect a fuel combustion phase.

A specific point that is used to detect the fuel consumption phase of the DHdP may be a 40% point.

Other aspects of the present invention are directed to a method for calculating the DHdP may include calculating by applying a motoring pressure (Pmotoring) and a pressure difference (Pdiff) that is formed by combustion instead of a cylinder measure pressure P in a conventional heat release equation, and calculating an approximate heat release value by ignoring a heat release rate by the motoring pressure of a very small amount, calculating heat release by considering a combustion characteristic that is formed at a top dead center area that a volume variation is small and ignoring a dV factor that is relatively small, and calculating a heat release DHdP as follows:

$$\frac{d Q}{d θ} = \frac{1}{γ - 1} V \frac{d P}{d θ} + \frac{γ}{γ - 1} P \frac{d V}{d θ}$$

$$\frac{d Q}{d θ} = \frac{1}{γ - 1} V \frac{d ( {P}_{diff} + {P}_{motoring} )}{d θ} + \frac{γ}{γ - 1} ( {P}_{diff} + {P}_{motoring} ) \frac{d V}{d θ} , \\ where$$

$${P}_{diff} = P - {P}_{motoring}$$

$$\frac{d Q}{d θ} = \frac{1}{γ - 1} ( V \frac{d {P}_{diff}}{d θ} + γ {P}_{diff} \frac{d V}{d θ} ) + \frac{1}{γ - 1} ( V \frac{d {P}_{motoring}}{d θ} + γ {P}_{motoring} \frac{d V}{d θ} ) \\ \frac{d Q}{d θ} = \frac{1}{γ - 1} ( V \frac{d {P}_{diff}}{d θ} + γ {P}_{diff} \frac{d V}{d θ} ) \\ \frac{d Q}{d θ} = \frac{1}{γ - 1} V \frac{d {P}_{diff}}{d θ} .$$

Other aspects of the present invention are directed to an incipient combustion heat generation rate detection method and combustion phase detection in which an incipient heat generation rate can be detected through a small amount of calculation, compared to a conventional heat generation rate detection method, and a combustion phase can be detected in real time by using a specific point of an incipient heat generation rate. This can be effectively applied to a combustion phase control system such that injection and ignition delay time between combustion chambers or between cycles is compensated, the exhaust gas is reduced, and the combustion stability is improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a conventional method for combustion phase control.

FIG. 2 shows that many errors are generated in a combustion phase, in case an offset is generated in a sensor measure value by heat impact when a cylinder combustion pressure is measured, wherein the upper curve is a normal cylinder pressure and the lower curve is a cylinder pressure in a case of an offset.

FIG. 3 shows a result of a combustion phase detection, which uses a 50% point of heat release (e.g., 50% of fuel mass burned or MFB50), wherein an upper end square mark is a combustion phase when a cylinder pressure offset occurs, and a lower end circle mark is an MFB50 of a normal condition to show that there is an error as large as a height difference between both sides in combustion phase detection.

FIG. 4 is a combustion pressure and motoring pressure graph.

FIG. 5 is a graph that compares DHdP as heat release of the present invention with a conventional heat release.

FIG. 6 is a graph showing a relationship between a crank angle and a normalized value of DHdP of the present invention.

FIG. 7 is a graph showing a 40% point of DHdP, which is normalized, according to fuel injection timing of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A conventional fuel injection system uses feed-forward control. However, in spite of an equal fuel injection order, in a case that fuel injection is controlled by feed-forward control, the injection and the ignition can be delayed according to driving conditions of an engine such that the combustion phase is varied. Since the variation of the combustion phase increases exhaust gas or decreases combustion stability, the combustion phase is to be accurately controlled by feedback control.

For this, a conventional combustion phase detection method for controlling a combustion phase detects a combustion phase by using a specific point of heat release (for example, 50% of fuel mass burned, or MFB50), but it may cause an error of the combustion phase when an offset is generated by the cylinder pressure sensor and a calculation load is high such that real time control is hard to realize.

Given this point, because a difference of the combustion pressure and the motoring pressure are used in the present invention, it is not affected by an offset of the cylinder pressure, and a calculation load thereof is low in contrast to the conventional method to estimate a heat generation rate and a heat release at an early stage of the combustion with ease, and the method will be described hereafter.

The following Equation 1 is used to calculate a heat generation rate, a conventional cylinder measure combustion pressure P minus pressure (Pmotoring) is a pressure difference (Pdiff) that is generated by combustion to effectively control combustion, i.e. Pdiff=P−Pmotoring or P=Pdiff+Pmotoring, Pdiff+Pmotoring is applied instead of P in a conventional equation.

$$\frac{d Q}{d θ} = \frac{1}{γ - 1} V \frac{d P}{d θ} + \frac{γ}{γ - 1} P \frac{d V}{d θ} \qquad Equation 1$$

And the heat generation rate of Equation 2 according to the present invention can be received:

$$\frac{d Q}{d θ} = \frac{1}{γ - 1} V \frac{d ( {P}_{diff} + {P}_{motoring} )}{d θ} + \frac{γ}{γ - 1} ( {P}_{diff} + {P}_{motoring} ) \frac{d V}{d θ} , \\ where {P}_{diff} = P - {P}_{motoring} \qquad Equation 2$$

The above Equation 2 is arranged to be transformed to a following Equation 3.

$$\frac{d Q}{d θ} = \frac{1}{γ - 1} ( V \frac{d {P}_{diff}}{d θ} + γ {P}_{diff} \frac{d V}{d θ} ) + \frac{1}{γ - 1} ( V \frac{d {P}_{motoring}}{d θ} + γ {P}_{motoring} \frac{d V}{d θ} ) \qquad Equation 3$$

However, the heat generation rate by the motoring pressure is a value that can be omitted in Equation 3, and resultantly the heat generation rate can be expressed as the following Equation 4 as an approximate value.

$$\frac{d Q}{d θ} = \frac{1}{γ - 1} ( V \frac{d {P}_{diff}}{d θ} + γ {P}_{diff} \frac{d V}{d θ} ) \qquad Equation 4$$

Meanwhile, since the combustion is generated at a top dead center area of a compression stroke in which the cylinder volume and the volume variation show the lowest value, the dV section of Equation 4 can be omitted, which is smaller than the dPdiff (because in a condition that the mixture is exploded by a combustion reaction, the pressure is quickly increased for a very short time and the instant pressure difference is large, and a volume variation for the equal time, i.e., the descent of the piston that is formed by the explosion pressure is only a small value compared to the pressure variation), the heat generation rate at a top dead center area where the volume variation is low can be expressed as an approximate value such as in Equation 5.

$$\frac{d Q}{d θ} = \frac{1}{γ - 1} V \frac{d {P}_{diff}}{d θ} \qquad Equation 5$$

Consequently, the heat generation rate is integrated according to a crank angle as shown in Equation 6 to calculate a combustion early stage heat release of an engine (a conventional heat release is calculated to get Equation 7 by integrating Equation 1), and for this, if Equation 5 is integrated, a combustion early stage heat release (hereinafter, this can be called DHdP (difference pressure heat release using the dP term)) suggested in the present invention can be calculated, the integration equation thereof is shown in Equation 8, a characteristic of DHdP that is to be described hereafter is used to detect/calculate a combustion phase, and if this combustion phase is used, the combustion phase can be properly controlled.

$$\begin{matrix}{\int }_{SOC}^{EOC} V \frac{d {P}_{diff}}{d θ} d θ & Equation 6 \\ Heat release \text{:} \int ( \frac{1}{γ - 1} V \frac{d P}{d θ} + \frac{γ}{γ - 1} P \frac{d V}{d θ} ) d θ & Equation 7 \\ DHdP \text{:} \int \frac{1}{γ - 1} V \frac{d {P}_{diff}}{d θ} d θ & Equation 8\end{matrix}$$

Equation 9 is used to have a normalizing DHdP and a specific position of the normalized DHdP (for example, 40% point of DHdP is used between 0 and 50%) is used to detect a combustion phase according to a fuel injection moment. The combustion phase that is detected/calculated as above is applied to combustion phase control such that a combustion phase is accurately controlled according to driving conditions.

$$Normalized DHdP : \frac{\int V \frac{d {P}_{diff}}{d θ} d θ}{max ( \int V \frac{d {P}_{diff}}{d θ} d θ )} \qquad Equation 9$$

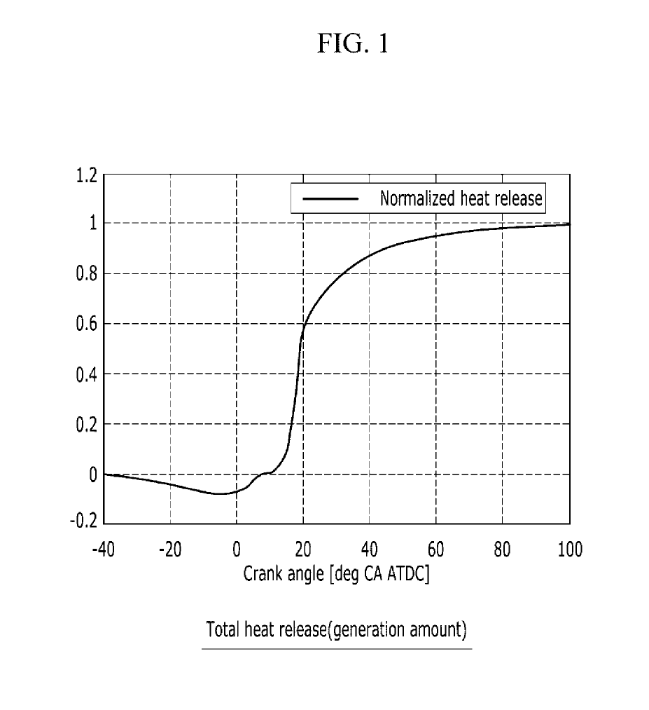

FIG. 1 is a graph showing a result of total heat release that is calculated by detecting a combustion pressure inside a combustion chamber and substituting the detected pressure into Equation 1. This is a conventional method for combustion phase control, wherein a specific point of the total heat release (for example, 0.5 of axis y, that is a 50% point) is used to detect a combustion phase, but this is mathematically very complicated and a calculation load thereof is high as described above and therefore it is hard to apply this method in real time.

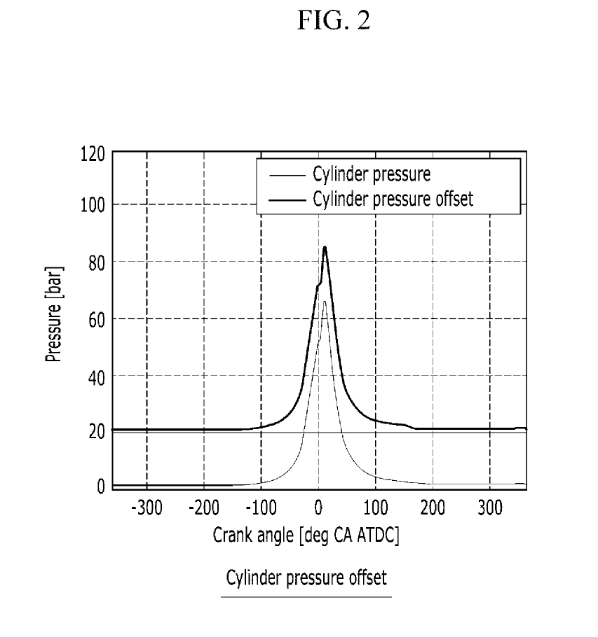

Also, as shown in FIG. 2, in a case that an offset is generated in a measured value of a sensor by a heat impact when a cylinder combustion pressure is measured, a larger error is formed in a combustion phase. The upper curve is a normal cylinder combustion pressure, the lower curve is a cylinder pressure in an offset case, and a difference between both curved lines is an error.

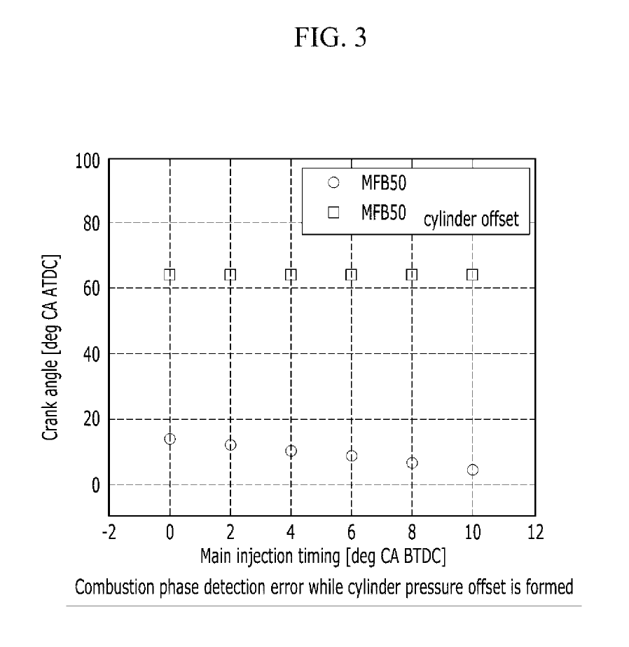

FIG. 3 shows a result of combustion phase detection, which uses a 50% point (MFB50) of heat release, wherein an upper end square mark is a combustion phase when a cylinder pressure offset occurs, and a lower end circle mark is an MFB50 of a normal condition to show that there is an error as large as a height difference between both sides in combustion phase detection.

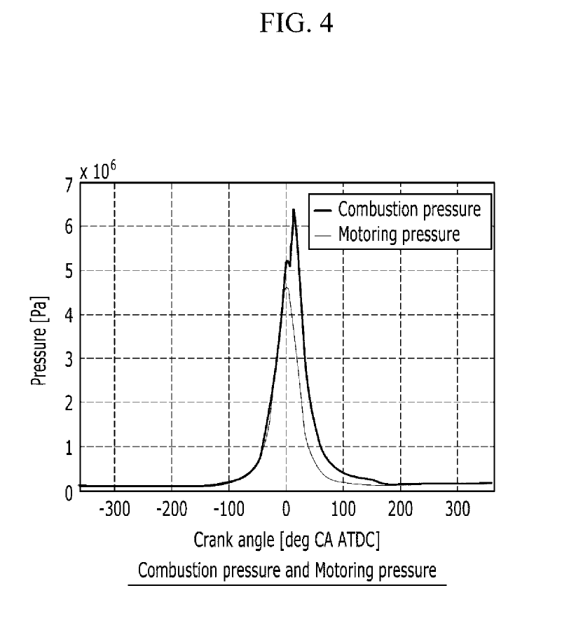

FIG. 4 is a combustion pressure and motoring pressure graph, wherein a cylinder combustion pressure curve and a motoring pressure curve coincide at the left side of a peak point, and there is a little difference therebetween at the right side thereof.

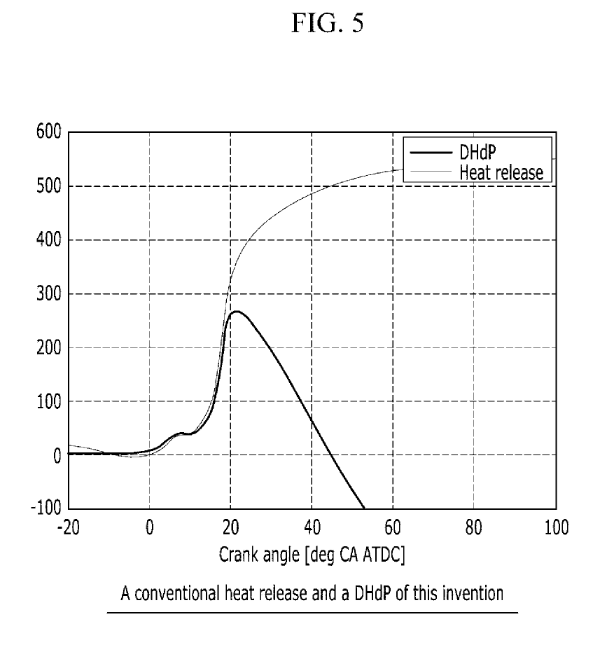

FIG. 5 is a graph that compares DHdP as a heat release of the present invention with a conventional heat release, and compares heat release (DHdP) of the present invention that is calculated by integrating 1/(γ−1)*V dPdiff/dθ of Equation 5 like Equation 8 with a heat release (referring to Equation 7) that is calculated by integrating a conventional Equation 1, if both curves are compared, it shows that heat release DHdP of a combustion early stage and middle stage (until a crank angle of 20° along an axis X) almost coincides with heat release that is calculated by a conventional heat release Equation 7, and the main point of the present invention includes using a characteristic of the coincidental range.

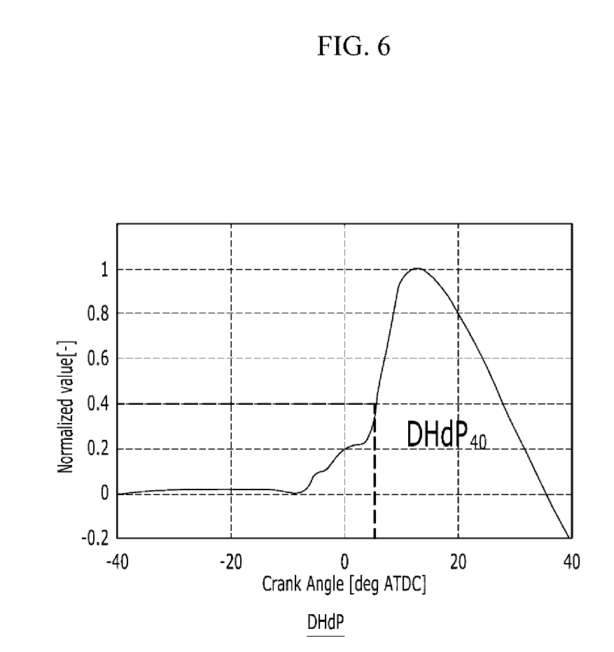

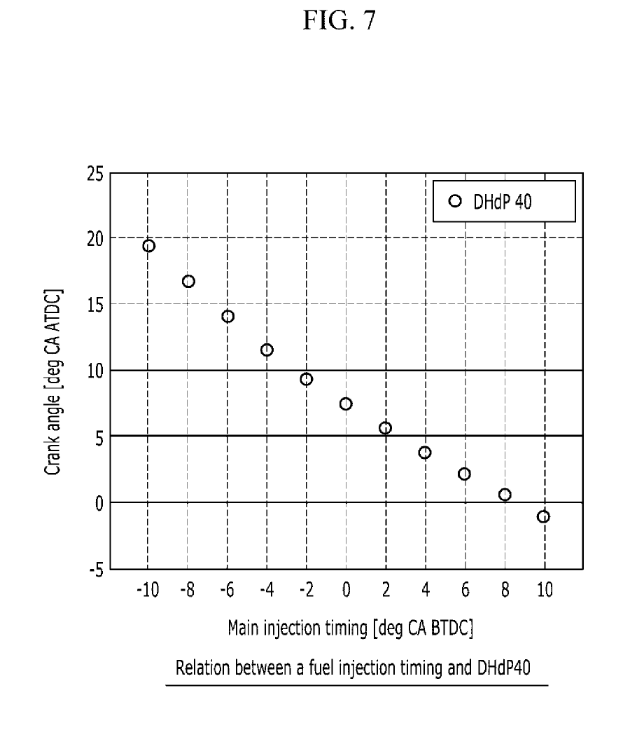

FIG. 6 is a graph showing a relationship between a crank angle and the DHdP value that is normalized, and different from as described for the above FIG. 5 where a heat release range from 0 to 50% is normalized during a combustion process, the DHdP40 of a desirable 40% point between the range (referring to DHdP40 0.4 of an axis y and a crank angle of 5° of an axis x in FIG. 6) shows a condition that conventional heat release shows an equal characteristic (both curves almost coincide with each other), and therefore if a specific 40% point of the normalized DHdP is used, a combustion phase can be detected according to fuel injection timing, and this is shown in FIG. 7 as a graph showing a 40% point of DHdP according to fuel injection timing, so it can be confirmed that a combustion phase is well varied according to fuel injection timing. Accordingly, if the characteristic is used, a combustion phase according to fuel injection timing can be accurately and simply detected.

For convenience in explanation and accurate definition in the appended claims, the terms upper, or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A combustion phase detection method of an engine, comprising:
detecting a combustion phase according to fuel injection timing by using a specific point of DHdP that is calculated by the following heat release equation:
$$DHdP \text{:} \int \frac{1}{γ - 1} V \frac{d {P}_{diff}}{d θ} d θ$$
wherein Pdiff is a difference (Pdiff=P−Pmotoring) between a cylinder measure combustion pressure (P) and a motoring pressure (Pmotoring).

2. The combustion phase detection method of claim 1, wherein the DHdP is normalized by:
$$Normalized DHdP : \frac{\int V \frac{d {P}_{diff}}{d θ} d θ}{max ( \int V \frac{d {P}_{diff}}{d θ} d θ )} .$$

3. The combustion phase detection method of claim 2, wherein the specific point of the DHdP ranging from 0 to 50% is used to detect a fuel combustion phase.

4. The combustion phase detection method of claim 3, wherein a specific point that is used to detect the fuel consumption phase of the DHdP is a 40% point.

5. The combustion phase detection method of claim 1, wherein a method for calculating the DHdP includes:
$$\begin{matrix}\frac{d Q}{d θ} = \frac{1}{γ - 1} V \frac{d P}{d θ} + \frac{γ}{γ - 1} P \frac{d V}{d θ} & Equation 1 \\ \frac{d Q}{d θ} = \frac{1}{γ - 1} V \frac{d ( {P}_{diff} + {P}_{motoring} )}{d θ} + \frac{γ}{γ - 1} ( {P}_{diff} + {P}_{motoring} ) \frac{d V}{d θ} , \\ where {P}_{diff} = P - {P}_{motoring} & Equation 2 \\ \frac{d Q}{d θ} = \frac{1}{γ - 1} ( V \frac{d {P}_{diff}}{d θ} + γ {P}_{diff} \frac{d V}{d θ} ) + \frac{1}{γ - 1} ( V \frac{d {P}_{motoring}}{d θ} + γ {P}_{motoring} \frac{d V}{d θ} ) & Equation 3 \\ \frac{d Q}{d θ} = \frac{1}{γ - 1} ( V \frac{d {P}_{diff}}{d θ} + γ {P}_{diff} \frac{d V}{d θ} ) & Equation 4 \\ \frac{d Q}{d θ} = \frac{1}{γ - 1} V \frac{d {P}_{diff}}{d θ} & Equation 5\end{matrix}$$
calculating equations 2 and 3 by applying a motoring pressure (Pmotoring) and a pressure difference (Pdiff) that is formed by combustion instead of a cylinder measure pressure P in heat release equation 1;
calculating equation 4 as an approximate heat release value by ignoring a heat release rate by the motoring pressure of a very small amount in equation 3;
calculating heat release equation 5 by considering a combustion characteristic that is formed at a top dead center area where a volume variation is small and ignoring a dV factor that is relatively small in equation 4; and
calculating a heat release DHdP according to the equation of claim 1 by integrating the following equation:
$$Normalized DHdP : \frac{\int V \frac{d {P}_{diff}}{d θ} d θ}{max ( \int V \frac{d {P}_{diff}}{d θ} d θ )} .$$

6. A combustion phase detection system of an engine, comprising
an engine that uses a combustion energy to generate power; and
an ECU that detects the combustion timing,
wherein the ECU performs:
detecting a combustion phase according to fuel injection timing by using a specific point of DHdP that is calculated by the following heat release equation:
$$DHdP \text{:} \int \frac{1}{γ - 1} V \frac{d {P}_{diff}}{d θ} d θ$$
wherein Pdiff is a difference (Pdiff=P−Pmotoring) between a cylinder measure combustion pressure (P) and a motoring pressure (Pmotoring).

7. The combustion phase detection system of claim 6, wherein the DHdP is normalized by:
$$Normalized DHdP : \frac{\int V \frac{d {P}_{diff}}{d θ} d θ}{max ( \int V \frac{d {P}_{diff}}{d θ} d θ )} .$$

8. The combustion phase detection system of claim 7, wherein the specific point of the DHdP ranging from 0 to 50% is used to detect a fuel combustion phase.

9. The combustion phase detection system of claim 8, wherein a specific point that is used to detect the fuel consumption phase of the DHdP is a 40% point.

10. The combustion phase detection system of claim 6, wherein the ECU calculates the DHdP by performing:
$$\begin{matrix}\frac{d Q}{d θ} = \frac{1}{γ - 1} V \frac{d P}{d θ} + \frac{γ}{γ - 1} P \frac{d V}{d θ} & Equation 1 \\ \frac{d Q}{d θ} = \frac{1}{γ - 1} V \frac{d ( {P}_{diff} + {P}_{motoring} )}{d θ} + \frac{γ}{γ - 1} ( {P}_{diff} + {P}_{motoring} ) \frac{d V}{d θ} , \\ where {P}_{diff} = P - {P}_{motoring} & Equation 2 \\ \frac{d Q}{d θ} = \frac{1}{γ - 1} ( V \frac{d {P}_{diff}}{d θ} + γ {P}_{diff} \frac{d V}{d θ} ) + \frac{1}{γ - 1} ( V \frac{d {P}_{motoring}}{d θ} + γ {P}_{motoring} \frac{d V}{d θ} ) & Equation 3 \\ \frac{d Q}{d θ} = \frac{1}{γ - 1} ( V \frac{d {P}_{diff}}{d θ} + γ {P}_{diff} \frac{d V}{d θ} ) & Equation 4 \\ \frac{d Q}{d θ} = \frac{1}{γ - 1} V \frac{d {P}_{diff}}{d θ} & Equation 5\end{matrix}$$
calculating equations 2 and 3 by applying a motoring pressure (Pmotoring) and a pressure difference (Pdiff) that is formed by combustion instead of a cylinder measure pressure P in a conventional heat release equation 1;
calculating equation 4 as an approximate heat release value by ignoring a heat release rate by the motoring pressure of a very small amount in equation 3;
calculating heat release equation 5 by considering a combustion characteristic that is formed at a top dead center area where a volume variation is small and ignoring a dV factor that is relatively small in equation 4; and
calculating a heat release DHdP according to claim 6 by integrating equation 5.

11. The combustion phase detection method of claim 3, wherein a normalized heat release is divided into a before-peak area and an after-peak area, wherein the before-peak area is related to a first-half stage of combustion (DRdV 0-50%) and the after-peak area is related to a second-half stage of combustion (DRdV 51-100%).

12. The combustion phase detection system of claim 8, wherein a normalized heat release is divided into a before-peak area and an after-peak area, wherein the before-peak area is related to a first-half stage of combustion (DRdV 0-50%) and the after-peak area is related to a second-half stage of combustion (DRdV 51-100%).
